(19) United States
(12) Patent Application Publication
(10) Pub. No.: US 2014/0117960 A1
(43) Pub. Date: May 1, 2014

(54) ENHANCED SWITCHING REGULATOR CONTROLLER

(71) Applicant: SEAGATE TECHNOLOGY LLC, Cupertino, CA (US)

(72) Inventor: Brian Dean Boling, Broomfield, CO (US)

(73) Assignee: SEAGATE TECHNOLOGY LLC, Cupertino, CA (US)

(21) Appl. No.: 13/664,223

(22) Filed: Oct. 30, 2012

(51) Int. Cl. G05F 1/10

(52) U.S. Cl. 323/282

(57) ABSTRACT

In accordance with one embodiment, a system is provided that can include a voltage regulator controller configured to switch a power circuit based on a trigger. A linear scaler can generate an adjustment value based on a reference voltage and a regulated output voltage. This adjustment value can be used to generate the trigger to switch the power circuit based on the adjustment value.

### BACKGROUND

Electronic devices encounter different loads during their use. For example, a disc drive may encounter a need for more electrical current in order to write data to the disc than is required to read data from the disk. An inductor is often used as part of the power supply for electronic devices. When the load for the electronic device changes, the inductor can produce audible noise that can be heard by humans and sometimes be annoying.

### SUMMARY

This Summary is provided to introduce a selection of concepts in simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims

In accordance with one embodiment, a system is provided that can include a voltage regulator controller configured to switch a power circuit based on a trigger. A linear scaler can generate an adjustment value based on a reference voltage and a regulated output voltage. This adjustment value can be used to generate the trigger to switch the power circuit.

### BRIEF DESCRIPTION OF THE DRAWINGS

FIG. 1 illustrates a block diagram of a circuit for use in performing an enhanced peak current/minimum off-time control in accordance with one embodiment.

FIG. 2 illustrates a circuit for controlling the peak current of an inductor in a power supply device in accordance with one embodiment.

FIG. 3 illustrates another circuit for controlling the peak current of an inductor in a power supply device in accordance with another embodiment.

FIG. 4 illustrates a circuit for determining an adjustment value in accordance with one embodiment.

FIG. 5 illustrates an example of a circuit for controlling the peak current of an inductor in a buck-regulator circuit, in accordance with one embodiment.

FIG. 6 shows a flow chart illustrating a method of controlling the peak current in an inductor in a power supply device in accordance with one embodiment.

### DETAILED DESCRIPTION

Regulators that are used for current generation power devices can exhibit switching in a frequency band that produces acoustic emissions. Such acoustics can be annoying to humans and can also cause sensors such as shock or rotational vibration sensors to respond.

One type of regulator operates on the principle of charging an inductor to a fixed current level and transferring resulting inductor energy to one of the two outputs each switching cycle. Fixed peak inductor current threshold is selected to support rated output power, implying that substantial energy is delivered to the output each switching cycle under light load conditions. Excess energy delivery causes output voltage overshoot, with the regulator effectively coasting for a relatively long time duration as output voltage slowly decays under the influence of light load current.

A peak current/minimum off-time control circuit is used to control the amount of time that the charging cycle of the inductor is turned off. A peak current minimum off time control confronts two conflicting issues:

1) the need to deliver maximum output required for the load; and

2) at light load, the need to keep the switching frequency outside of the human audible range, e.g., the range from 20 Hz to 20 kHz.

Classical peak current/minimum off-time control relies on a fixed peak inductor current threshold. As a result, satisfying maximum output power and minimum switching frequency requirements represents a balancing act for such circuits. In some instances, simultaneously meeting such goals may not be possible via a fixed peak current threshold, particularly in applications where output power range spans several orders of magnitude.

In accordance with one embodiment, a system is provided that can automatically adjust inductor peak current threshold based on load current. This simplifies the task of both providing rated output power and avoiding light load switching frequencies. This embodiment can provide a self-contained solution that does not require a user to intervene to select different peak current levels based on drive operational mode. This can be referred to as an enhanced peak current minimum off-time control scheme that automatically adjusts the peak inductor current based on load.

In classical peak current/minimum off-time control, a switching cycle is initiated when output voltage is sensed out of regulation. A switching element is engaged, thus imposing voltage across the regulator inductor, with inductor current ramping upward in a nearly linear fashion. Via a current sensing mechanism, a signal proportional to inductor current is generated, and this signal is compared against a fixed level corresponding to a user selected fixed peak current limit. When sensed inductor current reaches the prescribed (fixed) level, the aforementioned switching element is disengaged, and remains so until the selected minimum off-time elapses. If output voltage is out of regulation at that time, another switching cycle is initiated. Otherwise, no switching occurs until output voltage once again falls out of regulation.

In accordance with one embodiment, an enhanced peak current/minimum off-time control can be achieved. This solution allows for a shift in the regulated DC output voltage with load. In fact, this voltage shift can serve as the driving mechanism for automatic peak current adjustment. More specifically, a signal proportional to the difference between the target voltage and the actual output voltage can be subtracted from the sensed inductor current, prior to being compared against a fixed reference level.

In an alternative embodiment, a signal proportional to the difference between the target voltage and the actual output voltage can be added to a fixed reference level prior to comparison against the sensed inductor current.

In either of these embodiments, peak current can be increased with increasing load, thus enabling selection of a sufficiently low current limit so as to provide a switching frequency that does not fall within the audio band at minimum load. As load increases, the peak inductor current limit is increased, thus enabling delivery of required output power. Referring now to the figures, different embodiments can be described in more detail.

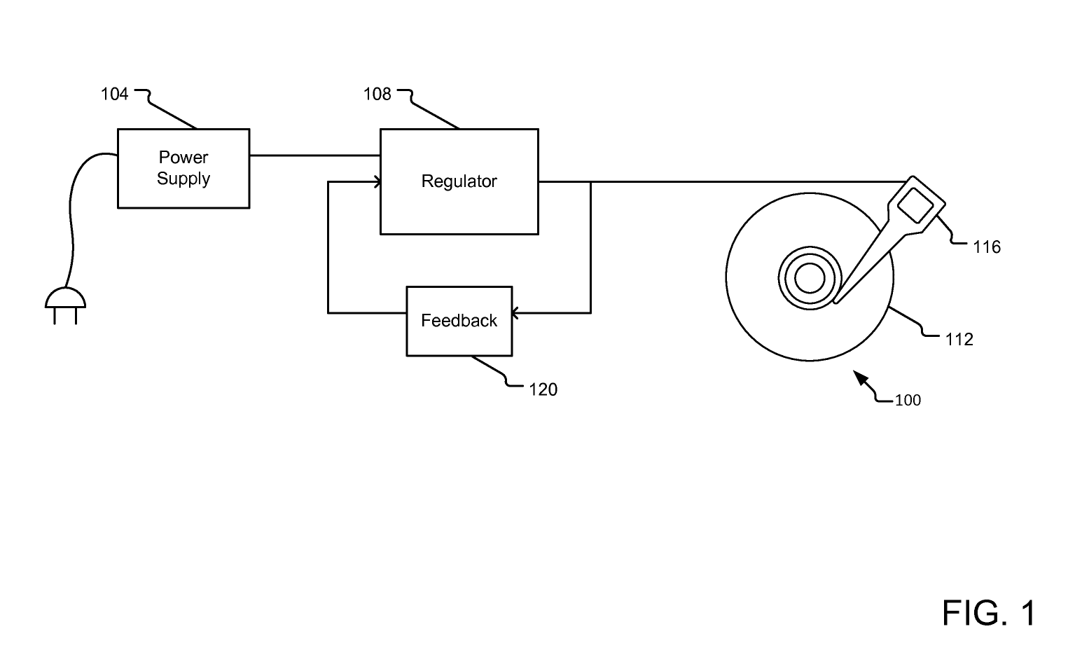

FIG. 1 illustrates as an example a disc drive system 100. A power supply 104 generates an output voltage that is regulated by regulator 108. The regulated voltage is supplied to the read/write head of the disc drive that controls armature 116 and platter 112. In this example, the regulated output voltage could be for a preamplifier for the read/write channel. Such a read/write channel might require a constant voltage supply when the current load is 350 mA for purposes of conducting a write operation. In contrast, a read operation might only require 10 mA for the same constant voltage supply. During periods of non-use, the regulator would be turned off.

While a disc drive is utilized as the example in this specification, it should be understood that the embodiments can equally be used for other types of devices and for a variety of converter topologies where peak current/minimum off-time control is applicable. Examples could include but not be limited to buck converters, boost converters, buck-boost converters, or combinations of the above such as the single inductor boost/buck-boost regulator described in U.S. Pat. No. 8,159,202.

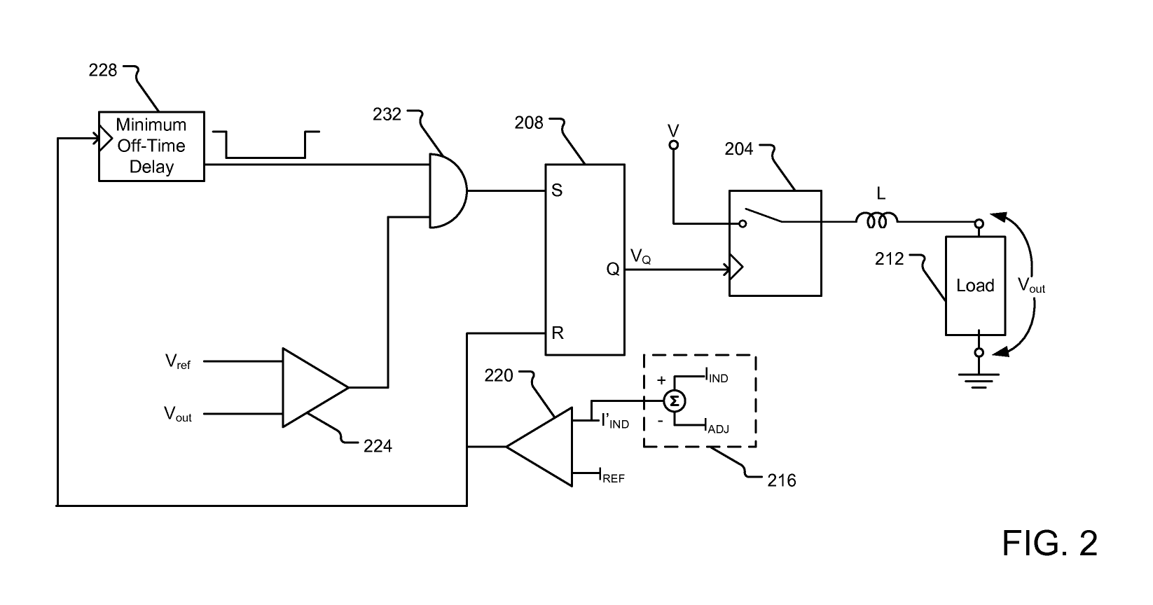

Referring now to FIG. 2, an example system 200 can be illustrated. In FIG. 2, an output voltage V controls a switch 204 (e.g., a field effect transistor) that effectively controls when a charging cycle should take place for charging a power supply inductor, L, when the load voltage, V_{OUT} is out of regulation.

Assuming that the voltage, Vout, is out of regulation with respect to a reference V_{REF}, comparator 224 will produce a high output signal indicating that Vout is out of regulation. This high signal will be input to AND gate 232 along with the output from the minimum off-time delay circuit 228. One circuit that can be used for the minimum off-time delay circuit is a one-shot circuit with an active low output. Assuming at this stage that the minimum off-time delay circuit has not been triggered, the output from the minimum off-time delay will be a high signal. Thus, the AND gate 232 will read a high signal from the comparator and a high signal from the minimum off-time delay circuit and output a high signal as well.

The high output signal will be read at the SET input of the SR flip flop 208. In response to the input, the output Q of the SR flip flop will be set to a high value. This output value will in turn be used as an input to a switching circuit 204 that switches on a charging cycle for the power supply inductor L.

The current through inductor L can be measured and compared to a reference current I_{REF}. FIG. 2 actually shows that the inductor current I_{IND} can first be adjusted. That adjustment will be described below in more detail. When the current through the inductor reaches the I_{REF} value, then, the comparator 220 will produce a high output signal. This high output signal will trigger the minimum off-time delay circuit 228 causing it to produce a low output. Thus, regardless of whether the output of 224 is still high (indicating that the voltage is out of regulation) the AND gate will produce a low output.

The SR flip flop will thus be experiencing a low input at S and a high input at R. The input at R (or reset) will cause the flip flop to reset Q to a low output. And, the fact that the input at S is now low will not trigger a high output for Q. Thus, the output Q will switch off the charging cycle for the power supply inductor and allow the current flowing through the inductor to decay.

The minimum off-time delay circuit will cause the charging cycle to remain off until the minimum off-time expires. Thus, for example, in the case of a one-shot, upon triggering the one-shot will cause the output of the one-shot to remain active low until the predetermined time period for the one shot expires.

Upon expiration of the minimum off-time delay, the process can be repeated. That is to say, that once the output voltage Vout is sensed to be out of regulation by comparator 224 and assuming that the output of comparator 220 is not yet a high output, then AND gate 232 will experience high input values on both of its inputs. This will produce a high output signal from AND gate 232 and cause SR flip flop to set Q to be a high signal. As a result, the signal V_{Q} will trigger the charging cycle for the inductor, L, again allowing current within that inductor to increase.

Referring now to the portion of the circuit outlined in block 216, the point at which the charging circuit is turned off can be adjusted. As the load increases for a power supply, the tendency is for the power supply output voltage to sag to some degree in response to the load. Normally, one designs the power supply so that the output voltage is as constant or as stable as possible in order to reduce this sag. However, by allowing some steady state d.c. voltage output error in the output voltage of the power supply (e.g., sag), one can cause the power supply to switch less frequently in the audible range by reducing the peak current limit.

FIG. 2 shows this adjustment in circuit 216. Circuit 216 sums the value of the current through the inductor, I_{IND}, with a negative value of a current adjustment value I_{ADJ}. I_{ADJ} can be based on the difference between V_{OUT} of the power supply and the reference voltage V_{REF} for the power supply. For example, I_{ADJ} could be computed as (V_{REF}−V_{OUT})k, where k is a gain value. Thus, by allowing some steady state d.c. voltage output error in the output voltage, V_{REF}−V_{OUT} will have a value greater than zero. Similarly, I_{ADJ} will have the value (V_{REF}−V_{OUT})k. When I_{ADJ} is subtracted from the actual current in the inductor, I_{IND}, the value I_{IND}′ will be lower than I_{IND}. Thus, the charging cycle will continue for a longer period of time in response to a sag in the output voltage before I_{IND}′ reaches the value of I_{REF}. As the difference between V_{REF} and V_{OUT} is permitted to increase, the length of a charging cycle will also be allowed to increase because I_{IND}′ will be adjusted even further from I_{REF}. Thus, the circuit allows for a peak current adjustment in response to encountering a higher load while controlling the frequency at which the charging cycle switches on and off.

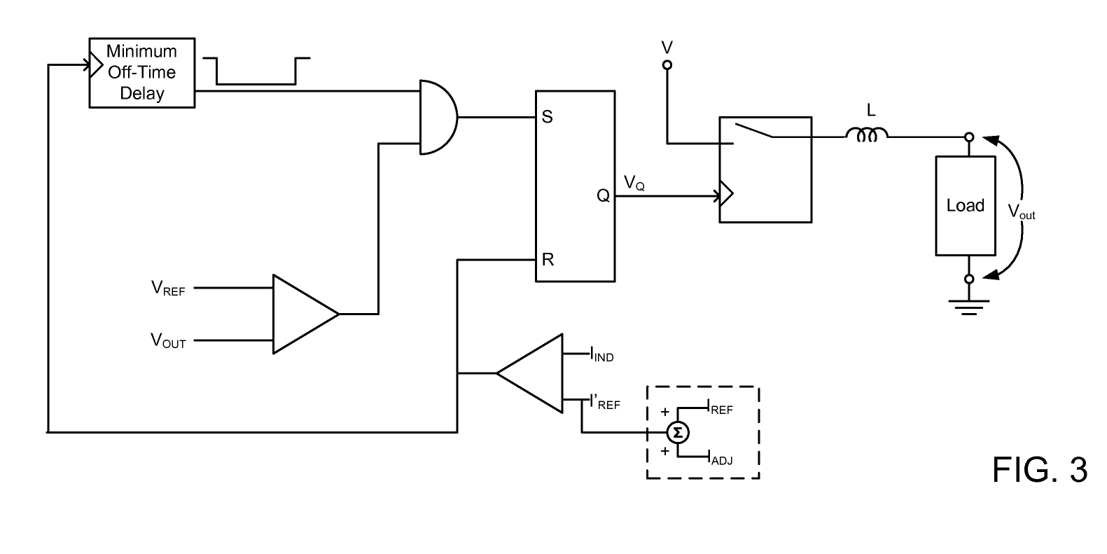

FIG. 3 illustrates another embodiment. In FIG. 3, the I_{ADJ} value is used to adjust the I_{REF} value rather than the I_{IND} value. The adjustment circuit 316 will be discussed with respect to FIG. 3; however, the remainder of FIG. 3 can be understood from the previous discussion of FIG. 2. So, it will not be described again. In FIG. 3, I_{ADJ} is added to the I_{REF} value. This causes the I_{REF}′ value to increase. So, the charging circuit will remain on for a longer period of time until the value of I_{IND} can reach the value of I_{REF}+I_{ADJ}. Thus, a sag in the output voltage of the power supply causes I_{ADJ} to be greater than zero because I_{ADJ} is (V_{REF}−V_{OUT})k. Because I_{ADJ} is greater than zero, I_{REF}′ will be a larger number and the charging circuit will remain on until I_{IND} can achieve a high enough value to equal I_{REF}+I_{ADJ}. It should be noted that when the minimum off time delay circuit is active (e.g., active low) that the charging cycle will necessarily be prevented from being on.

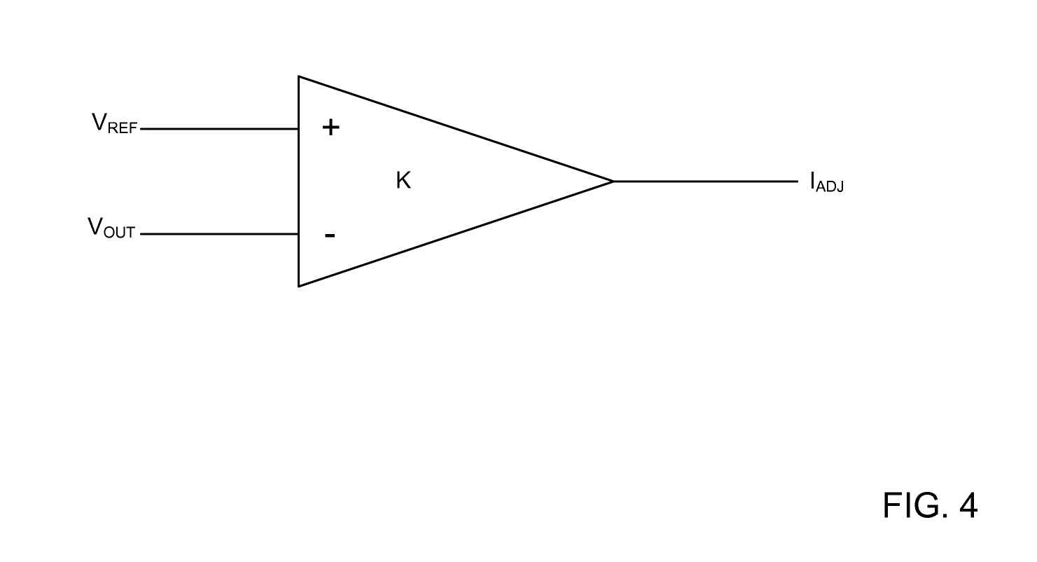

Referring now to FIG. 4, one embodiment for determining an adjustment value, I_{ADJ}, can be seen. In FIG. 4, a reference Voltage V_{REF} and the output voltage of the power supply, V_{OUT}, can be input to a differential amplifier. The differential amplifier can amplify the difference between the two values by some gain, k, to produce a value for I_{ADJ}. I_{ADJ} is thus referred to herein sometimes as a feedback based adjustment term.

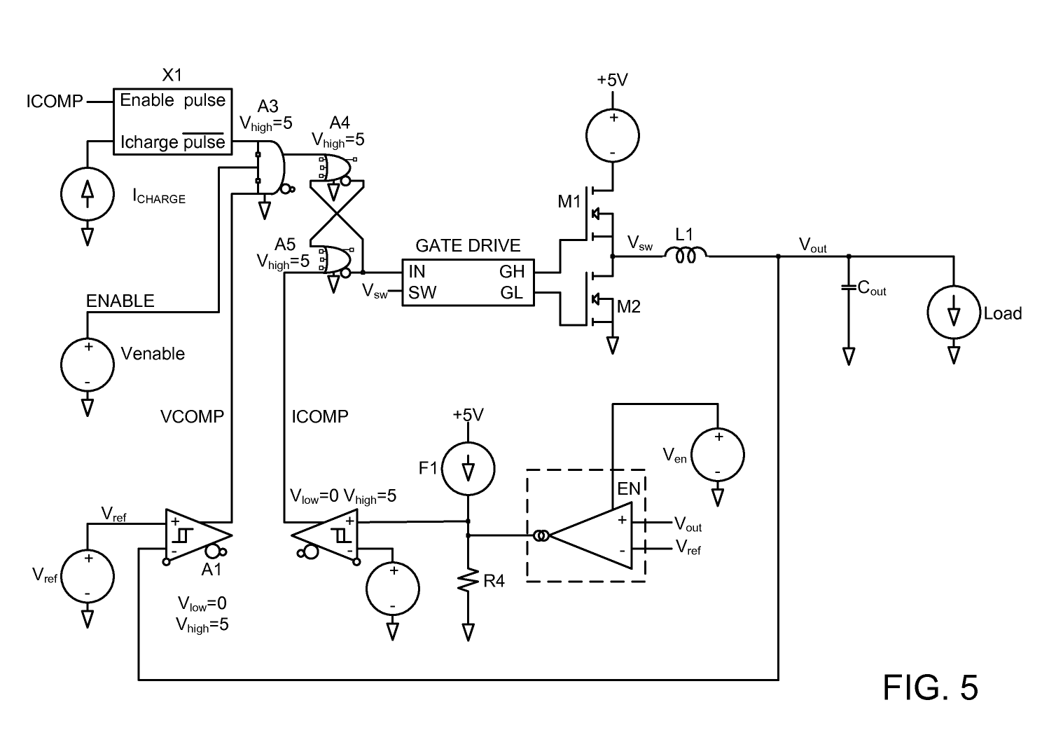

FIG. 5 illustrates another embodiment where the technique is shown being applied to a buck regulator. In FIG. 5, comparator A1 senses output voltage with respect to a reference voltage, and forces output of the SR flip-flop comprised of NOR gates A4 and A5 to a high logic level when voltage falls out of regulation. Through the block labeled GATE DRIVE, high-side FET M1 is turned on, imposing voltage across inductor L1 and causing inductor current to begin ramping upward. Inductor current is sensed via the implied high-side FET current mirror comprised of voltage source Vsns and dependent current source F1, with resultant scaled current driven into resistor R4 to create a voltage representative of inductor current. Component A2 compares this voltage against a fixed limit, Vlimit, and resets the SR flip-flop when inductor current reaches the prescribed limit. With input to the GATE DRIVE block at a low logic level, high-side FET M1 turns off and low-side FET M2 turns on, enabling a low loss inductor current circulation path. One-shot X1 is triggered concurrent with the SR flip-flop output state change, and prevents initiation of another switching cycle until the one-shot timeout has expired.

Peak inductor current scaling is provided by the block labeled OTA, which is shorthand nomenclature for Operational Transconductance Amplifier. This block generates a current proportional to the difference between output and reference voltages (Vout and Vref, respectively) that is subtracted from current sourced by the implied F1 current mirror. It should be noted that the particular embodiment depicted in FIG. 5 relies on an OTA only capable of sinking current, and with no source capability. This constraint is not binding in the general implementation, where both sink and source capability may prove beneficial.

In concert with selected external components, the fixed current limit threshold defined by Vlimit can be chosen to ensure switching frequency greater than 20 KHz (outside the audio band) when operating at minimum load current. Output voltage error under these conditions is negligible, resulting in negligible current sunk by the OTA and an effectively constant current limit. At minimum load, the example of FIG. 5 operates in discontinuous conduction mode (DCM), where inductor current decays to zero each switching cycle.

As load current increases, so too does switching frequency, with switching cycles moving closer together in time to deliver more power to the output and maintain voltage in regulation. At a certain load current level, the DCM boundary is reached, making delivery of additional output power impossible under the constraint of predetermined peak inductor current. If output power further increases, output voltage begins to droop and higher peak inductor current is demanded via the OTA mechanism. Current limit threshold increases proportionally with output voltage error, enabling delivery of higher output power at the expense of steady state voltage accuracy. Note that care should be exercised in the choice of OTA gain. Excessive gain can result in an apparently unstable system, with peak inductor current exhibiting significant pulse-to-pulse excursions, while insufficient OTA gain can produce excessive DC level shift with load. In application, these factors may be weighed against each other to arrive at a reasonable compromise.

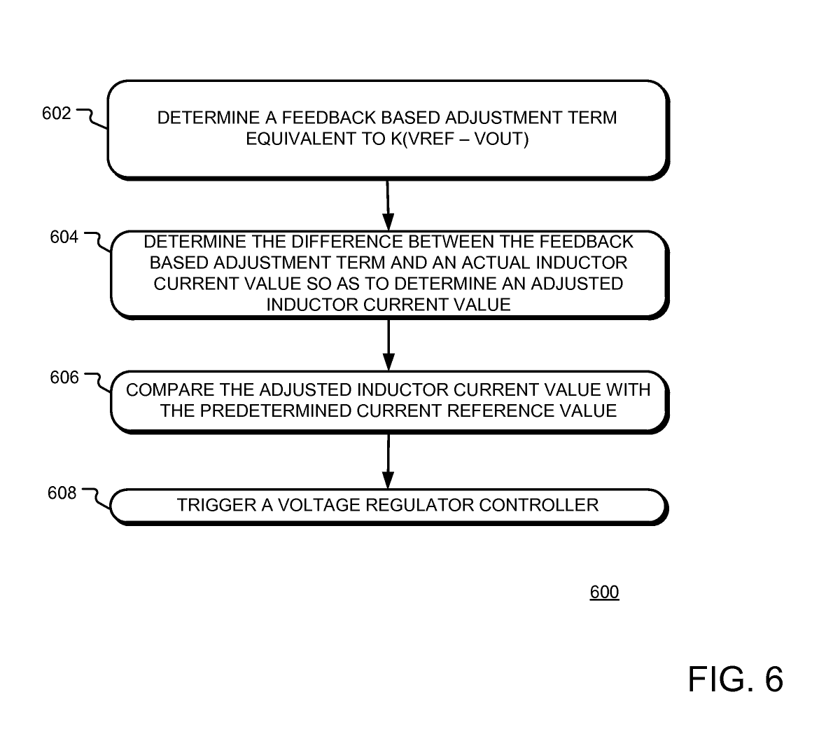

Referring now to FIG. 6, a flowchart 600 illustrates a method in accordance with one embodiment. The implementation of flowchart 600 can be better understood by reference to FIG. 2. In operation 602, a feedback adjustment term is determined. This term can be determined so as to be equivalent to k(V_{REF}−V_{OUT}). The value “k” represents a gain, such as the gain of an amplifier. The value V_{REF} is a predetermined reference voltage, such as a desired output voltage for a power supply. The value V_{OUT} represents the actual output voltage of the power supply. In operation 604, a determination can be made of the difference between the feedback based adjustment term and an actual inductor current value. This allows one to determine an adjusted inductor current value. In operation 606, the adjusted inductor current value may be compared with a predetermined current reference value. Based on this comparison, operation 608 shows that a voltage regulator controller may be triggered. By triggering the voltage regulator controller, for example, a power supply can be switched on to provide power to a load.

Although the block diagrams and flowcharts disclosed herein describe various embodiments in the context of storage devices for purposes of illustration and explanation, it is to be understood that the technology disclosed herein can be more broadly used for storage media beyond simply disk drives.

In one implementation, the block diagrams and flowcharts disclosed above are implemented in hardware and/or in software (including firmware, resident software, micro-code, etc.). Furthermore, various implementations may take the form of a computer program product on a non-transitory computer-usable or computer-readable storage medium having computer-usable or computer-readable program code embodied in the medium for use by or in connection with an instruction execution system. Accordingly, as used herein, the term “circuit” may take the form of digital circuitry, such as processor circuitry (e.g., general-purpose microprocessor and/or digital signal processor) that executes program code, and/or analog circuitry.

The embodiments of the invention described herein may be implemented as logical steps in one or more computer systems. The logical operations of the present invention may be implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. An apparatus comprising:
a voltage regulator controller configured to switch a power circuit based on a trigger;
a linear scaler configured to generate a feedback based adjustment term based on a reference voltage and a regulated output voltage; and
an adjuster configured to generate the trigger based on the feedback based adjustment term.

2. The apparatus as claimed in claim 1, wherein the feedback based adjustment term is equal to k(V_{REF}−V_{OUT}) wherein “k” represents a gain value, wherein V_{REF} is a predetermined reference voltage, and wherein V_{OUT} represents an output voltage for a load being powered by the power circuit.

3. The apparatus as claimed in claim 1, wherein the adjuster configured to generate the trigger based on the feedback based adjustment term comprises a circuit to compare an adjusted inductor current value with a predetermined current reference value.

4. The apparatus as claimed in claim 3 wherein the adjusted inductor current value is the difference between an actual inductor current value and the feedback based adjustment term.

5. The apparatus as claimed in claim 1 wherein the adjuster configured to generate the trigger based on the feedback based adjustment term comprises a circuit to compare an actual inductor current value with an adjusted predetermined current reference value.

6. The apparatus as claimed in claim 4 wherein the adjusted predetermined inductor current value is the sum of a predetermined inductor current value and the feedback based adjustment term.

7. The apparatus as claimed in claim 1 wherein the voltage regulator permits steady state voltage output error.

8. A method comprising:
triggering a voltage regulator controller based on a feedback based adjustment term generated from a reference voltage and a regulated output voltage.

9. The method as claimed in claim 8 wherein the feedback based adjustment term is equal to k(V_{REF}−V_{OUT}) wherein “k” represents a gain value, wherein V_{REF} is a predetermined reference voltage, and wherein V_{OUT} represents an output voltage.

10. The method as claimed in claim 8 wherein the triggering the voltage regulator controller based on the adjustment term generated from the reference voltage and the regulated output voltage comprises:
comparing an adjusted inductor current value with a predetermined current reference value.

11. The method as claimed in claim 10 wherein the adjusted inductor current value is the difference between an actual inductor current value and the feedback based adjustment term.

12. The method as claimed in claim 8 wherein the triggering voltage regulator controller based on the adjustment term generated from the reference voltage and the regulated output voltage comprises:
comparing an adjusted current reference value with an actual inductor current value.

13. The method as claimed in claim 12 wherein the adjusted current reference value is the sum of a predetermined current reference value and the feedback based adjustment term.

14. The method as claimed in claim 8 and further comprising:
permitting steady state voltage output error.

15. A circuit comprising:
a regulator controller configured to switch a power circuit based on a trigger, the trigger being generated based on a feedback based adjustment term based on the difference between a reference voltage and a regulated output voltage.

16. The circuit as claimed in claim 15 wherein the adjustment term is equal to k(V_{REF}−V_{OUT}) wherein “k” represents a gain value, wherein V_{REF} is a predetermined reference voltage, and wherein V_{OUT} represents an output voltage.

17. The circuit as claimed in claim 15 wherein the circuit comprises a comparator to compare an adjusted inductor current value with a predetermined current reference value.

18. The circuit as claimed in claim 17 wherein the adjusted inductor current value is the difference between an actual inductor current value and the feedback based adjustment term.

19. The circuit as claimed in claim 15 wherein the circuit comprises a comparator to compare an actual inductor current value with an adjusted predetermined current reference value.

20. The circuit as claimed in claim 19 wherein the adjusted predetermined inductor current value is the sum of a predetermined inductor current value and the feedback based adjustment term.
